(19) United States
(12) Patent Application Publication
(10) Pub. No.: US 2003/0041516 A1
(43) Pub. Date: Mar. 6, 2003

(54) Biodegradable plant shell

(76) Inventor: Lynnwood C. Cook, Destin, FL (US)

Correspondence Address: Waters & Morse, P.C., 400 Ledyard Building, 125 Ottawa, Avenue, NW, Grand Rapids, MI, 49503, US

(21) Appl. No.: 09/939,860

(22) Filed: Aug. 27, 2001

(51) Int. Cl. A01G 9/02

(52) U.S. Cl. 47/65.7

(57) ABSTRACT

A biodegradable plant shell comprises a mixture of particulate organic base material such as shredded southern pine bark or rice hulls in combination with peat moss, manure, top soil, time-release nutrients or other organic materials, and a water responsive biodegradable organic tackifier or glue. The components are mixed and compressed in the shape of a plant pot or shell having relatively thick walls. The shell retains its shape until used but disintegrates readily when the shell is planted in a moist environment. The walls permit root permeation, provide desirable water retention, and provide nutrition during plant development. The shells are sized to mate with standard sizes of temporary nursery pots and are inserted in the ground as a nutrient and water retention liner for a new plant. A series of shells of graduated sizes can fit inside each other to facilitate transplanting of plants during nursery development. Shells can be planted easily with a power auger employing special tapered bits with depth control paddles designed to fit the shells.

### BACKGROUND OF THE INVENTION

The present invention relates to an improved biodegradable plant shell and method of producing and using the shell so as to nourish and eliminate injury to plant roots during planting and transplanting operations.

When plants, especially woody plants, such as shrubs and small trees and certain ornamental grasses, are grown in nurseries, it is customary to grow the plants in a series of disposable plastic pots, using a small pot for a seedling and transplanting the plant to larger pots as the plant matures. Finally, when the plant is to be planted in the ground or in a permanent above ground pot, the plant is again transplanted from the disposable plastic pot into a larger hole in the ground or a permanent pot where additional fertilizer or soil are added around the plant to nourish the plant until the roots are established. Each time a plant is transferred to a new pot or is placed in the ground, an appropriate soil and nutrient mixture has to be prepared and applied around the plant. Different nurseries use different soil mixtures. These contain varying amounts of ingredients such as top soil, manure, peat moss, and time release fertilizers. A less expensive base material such as rice hulls or southern pine bark is often used to reduce the necessary quantities of other, more expensive components.

This process has a number of drawbacks. First, the process is labor intensive, with the plant requiring a new soil mixture and repotting a number of times as it is cultivated in a nursery. Also, transplanting itself can disturb plant roots and damage the plant. Finally, when a plant is placed in the ground, additional damage to the roots can occur during planting, and the plant may not be implanted in the ground with sufficient nutrients and soil to ensure a proper environment for healthy plant development. Also, any voids in the soil surrounding the roots can damage the plant. All of these conditions cause excessive plant loss and resultant plant replacement requirements, which are very expensive for nurseries.

In order to overcome these problems, a number of attempts have been made to develop biodegradable plant containers that can be planted in the ground along with the plant and will decompose over time.

An object of the present invention is to provide an improved plant shell that contains adequate nutrients for the development of the plant, will maintain its shape until used, and will break down readily and permit root and moisture penetration when the container and plant are deposited in the ground or otherwise subjected to moisture.

Another object of the present invention is to develop a biodegradable plant container of the type described employing highly effective and readily available organic materials.

### BRIEF SUMMARY OF THE INVENTION

In accordance with the present invention, a biodegradable plant shell comprises a mixture of a particulate organic base material such as shredded southern pine bark (rice hulls also work), peat moss, manure, top soil, time-release nutrients, and a biodegradable organic tackifier or other biodegradable, non-toxic glue material. The components are mixed and compressed in a mold in the shape of a plant pot or shell having relatively thick walls. The walls are compressed to the extent that the shell retains its shape, while still leaving the walls with sufficient porosity to permit root and water permeation during plant development. The walls start to break down in as little as one week and begin to lose their structural integrity within as little as one month after the shell is planted in the presence of water. Roots and moisture can penetrate the shell right away.

An advantage of the plant shell of the present invention is that it is formed with readily available materials that are highly effective for this purpose. Southern pine bark particularly is available in large quantities at relatively low cost. This provides an ideal medium for the plant shell of the present invention. Southern pine bark is available in relatively small one quarter inch chunks and fines, and when compressed, the pine bark tends to be transformed into a powdery substance. Rice hulls and other particulate organic materials also are suitable. When combined with the other ingredients and an organic tackifier such as a combination of guar gum and corn starch, or other water responsive glue in a moist environment and then compressed and dried, the resulting plant shell can maintain its structural integrity and remain self supporting indefinitely. Yet when planted and subjected to moisture, the shell is sufficiently porous that it permits root and water permeation into the walls of the plant shell and breaks down rapidly during plant development. Moreover, the shell provides a nutrient-rich surrounding of uniform thickness around the plant, providing nutrients and moisture for the growing plant while not impeding root development.

An advantage of southern pine bark is that it provides a slightly acidic pH, enhances porosity, compresses well into a self supporting shell, provides nutrients and decomposes readily. Other types of biodegradable shells, such as shells fabricated from peat moss, retain their shapes much longer, resist root penetration, and fail to break down for years sometimes.

The shell of the present invention has thick walls, preferably up to about two inches or so, so that the shell provides a substantial amount of nutrition for the developing plant.

The shells can be formed with tapered walls in graduated sizes, preferably including one gallon, two gallon, three gallon, and five gallon sizes, which are conventional shell sizes used in nurseries at the present time. When used as a final shell for planting a plant in the ground, the interior of the shell is shaped to mate with the exterior of the conventional temporary plastic pot sizes in which the plants are sold. The plant's contents can thus be removed from the temporary pot and inserted into the shell and planted, with no voids or nutrient deficiencies around the plant. This minimizes plant loss after plant installation. When used for intermediate transplanting of plants, the exterior sidewalls of the shells are provided in shapes to fit in standard temporary plastic pots, while interiors of the shells can be sized to mate with the exterior of the next smaller shell. Thus, one shell can simply be put in a next larger shell at the time that the plant requires more room for root development. Watering of the shell causes rapid structural deterioration of the inner shell and permits continued, unimpeded root growth. The use of graduated shells saves time and improves plant health. Rather than preparing a new soil mixture each time a plant requires a larger pot for more room for root development, the entire contents of one plastic container are placed as a unit in a shell in the next larger container. The thick walls of the shell in the larger container fill the container and eliminate the need for additional soil. After further plant development in the larger container, the larger container contents are then placed in a shell in a larger container yet when further root development space is necessary. Finally, the last entire container contents can be planted in the ground in a final shell that is inserted in the ground. The plant will then be surrounded by nutritious growing media that will sustain it in the ground until the plant roots become fully established.

The use of biodegradable plant shells of consistent and conventional sizes also facilitates installation of the plants by landscaping companies. A landscaper can employ a power auger having special tapered bits in graded sizes to accommodate a one gallon, two gallon or other plant shell size, and a depth paddle can be used to automatically control the depth of the auger. Thus, to install plants in a landscaping operation, the power auger can be used to drill a number of holes and then final shells can be dropped in the holes and plants inserted in the final shells without further landscaping and without the addition of any additional soil or nutrients around the plant.

These and other advantages of the present invention will hereinafter appear and for purposes of illustration but not of limitation, a preferred embodiment of the present invention is described in detail below and shown in the appended drawings.

### BRIEF DESCRIPTION OF THE SEVERAL VIEWS OF THE DRAWING

FIG. 1 is a perspective view of a plant shell in accordance with the present invention.

FIG. 2 is a plan view of the plant shell of the present invention.

FIG. 3 is a sectional side elevational view of the plant shell of the present invention.

FIG. 4 is another a sectional side elevational view of the plant shell of the present invention with a plant and soil mixture filling the interior void therein.

FIG. 5 is a sectional side elevational view showing two plant shells of graduated sizes fitting one inside the other.

FIG. 6 is a pictorial side view showing the use of an auger for producing uniform holes in the ground for receipt of plants in the plant shells of the present invention.

FIG. 7 is a side elevational view showing the plant of FIG. 5 being deposited in a plant shell in the hole produced by the auger of FIG. 6.

### DETAILED DESCRIPTION OF THE INVENTION

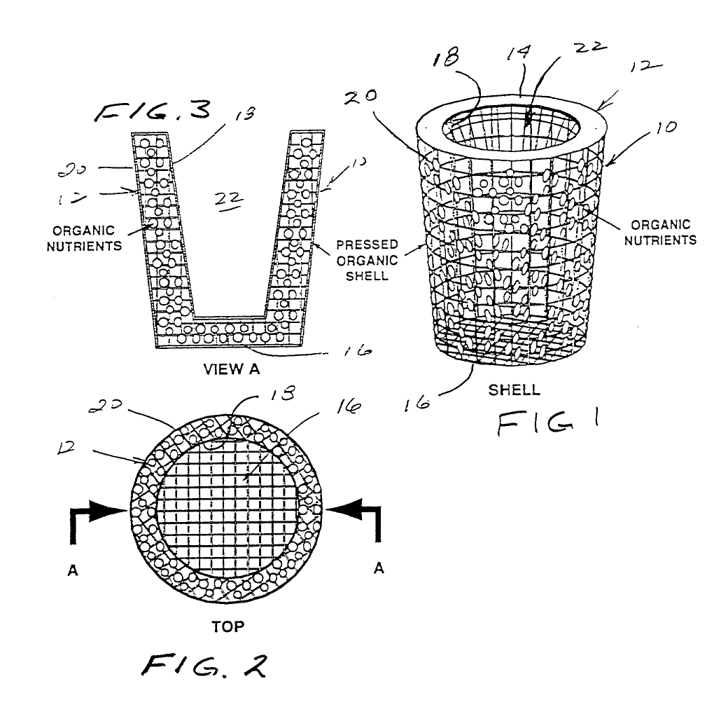

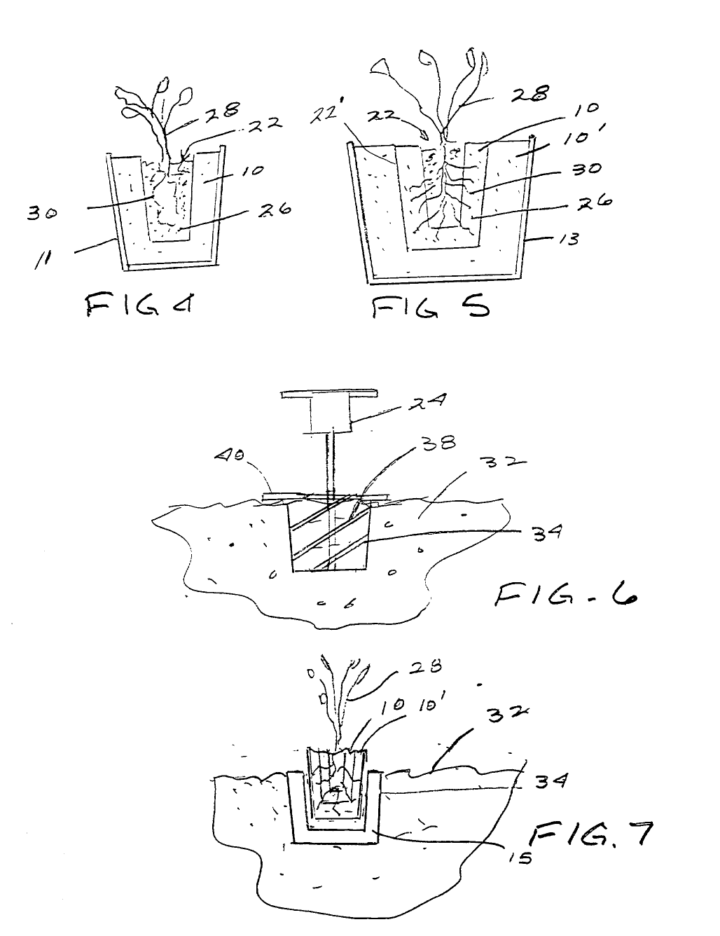

Referring to the drawings and more particularly to FIG. 1, plant shell 10 has slightly conical sidewalls 12, a top 14 and a bottom 16, all formed of the compressed organic materials described below. The sidewalls 12 include an inner wall 18 and an outer wall 20, both tapering downwardly and inwardly. Inner wall 18 and bottom 16 define an inner recess 22. Shell 10 may be one of a number of graduated sizes of shells. Conventionally, in the nursery business, temporary plastic pots are provided in standard sizes, such as one gallon, two gallon, three gallon, and five gallons, with the sizes indicating the volume of the container. The same conventional exterior sizes are used for the shells of the present invention, because they represent conventional sizes when plants are transplanted from one pot to a larger pot. The walls of the container are typically about two inches thick but can vary so that graduated shells fit in one another.

The use of the shells of the present invention for intermediate transplanting of growing plants is shown in FIGS. 4 and 5. As shown in FIG. 5, the shells can be produced in a number of graduated sizes. Shell 10 may be a one gallon size so it fits in a one gallon temporary plastic pot 11. Shell 10′ maybe two gallon size so it fits in a two gallon temporary plastic pot 13. Shell 10′ can have an inner recess 22′ shaped to fit closely over the exterior of shell 10. A number of different sizes of shells may be produced. The shells fit together in mating fashion, as shown in FIG. 5, with minimal air space between the two shells in a graduated series. Thus, when a plant outgrows a smaller shell, the smaller shell 10 can be removed from the temporary pot 11 (the root permeation will hold the contents together) and placed in the recess in shell 10′. The plant is then watered, and the plant growth will continue to develop through the decomposed biodegradable walls of the shell 10′.

As shown in FIG. 4, when a new plant 28 or seed is first introduced into the recess 22 in the smallest shell employed, the recess is filled with additional soil and other fill material 26 along with the plant roots 30 (or plant seed). Thereafter, the shell walls themselves of each succeeding plant container provide the nutrients and media for plant growth as the plant develops.

When a plant is to be planted in the ground 32 or in an above ground location, an auger 24, which may be a powered or manual auger, can be used to produce a hole 34 of a predetermined size in the ground. Since the containers are standard sizes, special tapered auger bits 38 matching these standard sizes may be used. These will produce holes for one gallon, two gallon, three gallon, or five gallon final shells 15 or other plantable sizes. A depth control paddle 40 or other appropriate mechanism is used to control the depth of the auger. Thus, an auger may be used to produce holes in the ground at all the desired locations and then final plant shells can simply be dropped into the holes. Plant contents are removed from disposable container 13 and are inserted in the final plant shells 15 and watered in order to complete the planting operation. There is no necessity to add soil, fertilizer, peat, or nutrients to the hole, since they are already incorporated into the plant shell. Since the holes are predrilled to be just the size of the plant shells, there is also no need to backfill the holes. This makes planting of plants in a landscaping situation very efficient and minimizes plant loss after the plants are installed.

While the use of standardized sizes and a compatible auger can expedite considerably the speed and success of landscaping operations, an auger is not necessary. Holes can be dug by hand and empty shells inserted in the holes. Plants can then be inserted in the shells and soils can be added inside and outside the shells as needed.

The organic materials from which the plant shell is made are selected to provide desirable nutrition, pH, and substantial water retention characteristics in a relatively inexpensive product. Desirably, the shell has a 20-50% and preferably a 30-40% water retention capability, has a slightly negative pH, has a sufficient percentage of larger particles to permit root and moisture permeation, and provides immediate and longer term nutrition for up to several months.

In one preferred practice of the present invention, the plant shell is made of shredded southern pine bark, manure (preferably cow manure), peat moss, top soil, and time-release nutrients and/or other man-made or organic materials. . These are combined in the presence of an organic tackifier agent or glue. A commercially available tackifier formed of guar gum and cornstarch manufactured by Conwed Fibers of North Carolina is satisfactory. Other tackifiers or water based glues that are biodegradable and non-toxic could be substituted. The tackifier acts as a lubricant and glue when combined with the water and the shell materials are compressed. The tackifier causes the shell to hold its shape until used so that it may be displayed and sold like a pot at a nursery. Yet the tackifier permits the rapid breakdown and decomposition of the shell when subjected to moisture.

The admixed constituents are placed in a mold and compressed until the tackifier sets. The pressure should be sufficient to reduce the uncompressed volume to the point where the shell holds its shape and has at least about 20% and preferably about 30-40% water retention. A holding time of 30 to 60 seconds is sufficient to set the shape of the shell. The pressure is high enough to cause the materials to hold their shape when dry while still leaving the shell porous enough to permit root and water penetration therethrough. Without water penetration, the shell takes much longer to break down. A compression of about 20% from the uncompressed volume of the components is generally sufficient to produce a stable product. An organic glaze may be sprayed on the outside of the shell if desired to resist decomposition from accidental contact with external moisture.

A starter pot for a new seedling or seed may be 100% southern pine bark. Thereafter, the ingredients of the present invention are preferably in the following proportions: organic particulate base material, such as shredded southern pine bark 50 to 90% (preferably 70%), peat moss 0 to 30% (preferably 10%), manure 0 to 30% (preferably 10%), top soil 0 to 30% (preferably 10%). Time-release fertilizer in varying amounts, depending upon the size of the container is added to the mixture. The amounts of time-release fertilizer are conventional and are frequently specified by the manufacturer of the time-release nutrient employed. Time release fertilizers come in various time release formulations, providing for nutrient release over various periods, such as six months, one year, and two years. Other time periods may be available. A fertilizer having a release time of six months to two years or more is preferred, with one year being satisfactory. A nursery could prefer a six month release, whereas a one to two-year release time might be desirable for final planting. A longer release time would not be undesirable, if available.

The tackifier, such as a guar gum, cornstarch combination, is added to the mixture in an amount sufficient to cause the shell to retain its shape when compressed.

An important ingredient of the present invention is the shredded bark. Southern pine bark has especially desirable attributes. Southern pine bark has a slightly acid pH, which most plants like. Some pine barks have an undesirable pH. Further, southern pine bark especially is available in large quantities at low cost. This product is generally available in relatively small chunks and fines. The chunks may be a quarter inch in diameter, for example. This material admixes well with the other ingredients and provides porosity as well as nutrients. With the product being as much as 70% of the relatively inexpensive southern pine bark, the cost of each shell is substantially reduced. Rice hulls and other organic base materials also work satisfactorily.

The particulate organic base material provides another important advantage. Whereas a solid peat moss shell (which is commonly known) does not decompose for a very long period of time in the ground, perhaps even years, southern pine bark and other particulate organic base materials break down and decompose quickly. The shell can be maintained in an above ground, unplanted condition for a substantial period of time, but when the shell is placed under conditions of moisture in the ground, or in another starter pot size, moisture penetrates the shell and the structure of the shell readily breaks down in no more than a few weeks. In the meantime, the shell is sufficiently porous that roots can readily permeate the walls of the container after introduction of moisture into the shell. Thus, plant roots can develop into the walls of the shell and be nourished by the shell almost immediately. In the meantime, prior to planting, the dry shell will retain its shape until it is used.

It should be understood that the foregoing is merely exemplary of the preferred practice of the present invention and that various changes and modifications may be made without departing from the spirit and scope of the present invention.

I claim:

1. A biodegradable plant shell comprising a peripheral wall having a hollow interior in which a plant is inserted, the wall having a substantial thickness and being formed of biodegradable constituents including a particulate organic base material and a water responsive glue, the shell being molded with sufficient porosity to permit root and water penetration into the walls of the shell, the glue being such that it causes the shell to retain its shape for storage and handling but permits the shell to disintegrate rapidly in the presence of water so as to facilitate root penetration through the wall and facilitate plant use of the water and nutrients retained in the shell.

2. A plant shell as in claim 1 wherein the major portion of the shell comprises the particulate organic base material in combination with organic ingredients that enhance water retention capabilities of the shell and time release nutrients in effective amounts to support initial plant development after a plant has been planted in the shell.

3. A plant shell as in claim 2 wherein the shell ingredients are compressed together sufficiently that the shell holds its shape when dry but is sufficiently porous that the shell permits root and water permeation therethrough but has substantial water retention capabilities.

4. A plant shell as in claim 3 wherein the shell comprises by volume at least about 50% of a particulate base material including one or a combination of southern pine bark and rice hulls.

5. A plant shell as in claim 3 wherein the shell includes effective quantities of peat moss, manure and top soil.

6. A plant shell as in claim 5 wherein the shell includes a time release fertilizer.

7. A plant shell as in claim 1 wherein the shell has a standard size outer shape such that the shell fits in standard size temporary plastic plant pots of the type that are used by nurseries.

8. A plant shell as in claim 1 wherein the shell has a standard size interior recess that is shaped such that plant contents developed in certain standard size temporary plastic pots will fit closely into the recess in the shell.

9. A plant shell as in claim 8 wherein the plant shell contains sufficient nutrients and water retention characteristics that the shell provides a desirable nutrition and water retention environment while a new plant is becoming established in a new environment.

10. A biodegradable plant shell according to claim 1 wherein the glue comprises guar gum, corn starch or a combination thereof.

11. A biodegradable plant shell according to claim 1 wherein the shell components are compressed in a mold at a pressure such that the shell walls are stable while dry, but the shell walls are sufficiently porous to permit water and root permeation into the walls of the shell, such that the shell structure breaks down substantially within a month in the pressure of moisture.

12. A biodegradable plant shell according to claim 1 wherein the shell is integrally molded in the presence of the glue under a pressure that is low enough that the shell retains sufficient porosity that water will permeate the shell when applied to a plant that is planted in the shell, the shell being formed from components and compressed at a pressure that is such that the shell retains at least about twenty percent (20%) of the water applied to it.

13. A biodegradable plant shell according to claim 15 wherein the shell has a water retention capability of 30-40%.

14. A biodegradable plant shell comprising a peripheral wall having a hollow interior in which a plant is inserted, the wall having a substantial thickness and being formed of biodegradable constituents including a particulate organic base material along with natural or synthetic nutrients dispersed therein, the base material and nutrients and thickness of the wall of the shell being sufficient to provide nutrition for the plant while the plant roots are becoming established, the constituents of the shell being sized, admixed and molded such that the shell retains a substantial amount of water yet is sufficiently porous to readily permit water and root penetration through the walls of the shell, the shell constituents being held together by a tackifying agent or glue admixed with the constituents, the tackifying agent or glue serving effectively as a water based glue that causes the shell to retain its shape for storage and handling but permitting the shell to disintegrate rapidly in the presence of water so as to facilitate root penetration through the wall and facilitate plant use of the water and nutrients retained in the shell.

15. A plant shell as in claim 14 wherein the major portion of the shell comprises the particulate organic base material in combination with organic ingredients that cause the shell to have sufficient water retention capabilities and sufficient time release nutrients to support initial plant development after a new plant has been planted in the ground when the shell is used as a liner for the plant when the plant is planted in the ground.

16. A biodegradable plant shell comprising a mixture of components including a base material comprising one or a combination of shredded pine bark and rice hulls, in combination with one or more elements selected from the group consisting of peat moss, manure, top soil, and time-release nutrients, held together by a water soluble tackifier or glue, with the components being mixed and compressed in the shape of a plant pot having relatively thick walls, the walls being compressed sufficiently that the shell retains its shape when dry, the walls being sufficiently porous to permit root and water permeation during plant development while still having substantial water retention capabilities, the walls being subject to rapid deterioration in the presence of moisture.

17. A biodegradable plant shell according to claim 10 wherein the components are present in the following percentages by volume:

| | |
|---|---|
| southern pine bark and/or rice hulls: | 50 to 100% |
| peat moss: | 0 to 30% |
| manure: | 0 to 30% |
| top soil: | 0 to 30% |

18. A biodegradable plant shell according to claim 10 wherein the components are present in approximately the following approximate percentages by volume:

| | |
|---|---|
| southern pine bark: | 70% |
| peat moss: | 10% |
| manure: | 10% |
| top soil: | 10% |
